(19) United States
(12) Patent Application Publication
(10) Pub. No.: US 2020/0034244 A1
(43) Pub. Date: Jan. 30, 2020

(54) DETECTING SERVER PAGES WITHIN BACKUPS

(71) Applicant: EMC IP Holding Company LLC, Hopkinton, MA (US)

(72) Inventors: Philip Shilane, Newtown, PA (US); Arun Chakravarthy, Bangalore (IN)

(21) Appl. No.: 16/046,212

(22) Filed: Jul. 26, 2018

(51) Int. Cl. G06F 11/14

(52) U.S. Cl. CPC G06F 11/1458; G06F 2201/80

(57) ABSTRACT

Segmentation of a backup or a backup stream. A backup is segmented using a window that is sized to correspond to a size of a header portion of a page of a database. The data in the window is evaluated to determine whether the data matches header criteria. The data may be evaluated with a stronger check as well. If the checks are positive or true, a page is located and subsequent pages can be located by advancing the window by the page size.

### FIELD OF THE INVENTION

Embodiments of the present invention relate to systems and methods for performing data protection operations. More particularly, embodiments of the invention relate to systems and methods for detecting server pages within backups.

### BACKGROUND

Databases (e.g., MS SQL SERVER) are an important application for many entities. Today, databases are protected by generating backup copies or by generating data that allows the databases to be restored when necessary. However, further protection is often warranted. For a variety of reasons, owners are expanding their view of data protection. In addition to backing up their data, database owners are considering encrypting their databases on primary storage before the database is backed up.

Backing up data that is compressed or encrypted introduces new problems. Although a data protection system can generate backups of encrypted data, the ability to deduplicate the data (and thereby conserve at least storage space) is reduced. For example, when the primary data is encrypted, the ability to find segments or pages becomes more difficult and the efficiency of the data protection system is reduced. While there are some algorithms that can be used to segment a backup (e.g., find pages), these algorithms are resource intensive and may actually slow the backup processes.

### BRIEF DESCRIPTION OF THE DRAWINGS

In order to describe the manner in which at least some aspects of this disclosure can be obtained, a more particular description will be rendered by reference to specific embodiments thereof which are illustrated in the appended drawings. Understanding that these drawings depict only example embodiments of the invention and are not therefore to be considered to be limiting of its scope, embodiments of the invention will be described and explained with additional specificity and detail through the use of the accompanying drawings, in which:

FIG. 1 is an example of a page, which is an example structure used in a database;

FIG. 2 illustrates and example of a method for segmenting a backup or a backup stream;

FIG. 3 is an example of a flow diagram for segmenting a backup or a backup stream; and

FIG. 4 is an example of pseudocode for segmenting a backup or a backup stream.

### DETAILED DESCRIPTION OF SOME EXAMPLE EMBODIMENTS

Embodiments of the invention relate to systems and methods for protecting data. Example data protection operations performed by a data protection system or application include backup operations, de-duplication operations, restore operations, or the like or combination thereof. Embodiments of the invention further relate to systems and methods for backing up data such as a database and to backing up and de-duplicating databases that have been encrypted on primary storage.

Embodiments of the invention are discussed with reference to a specific database structure such as used by a SQL server. Embodiments of the invention, however, are not limited to any particular database structure, application, or system. The principles discussed herein can be adapted to other structures of encrypted and/or compressed data including data that is stored in pages, blocks, streams or the like.

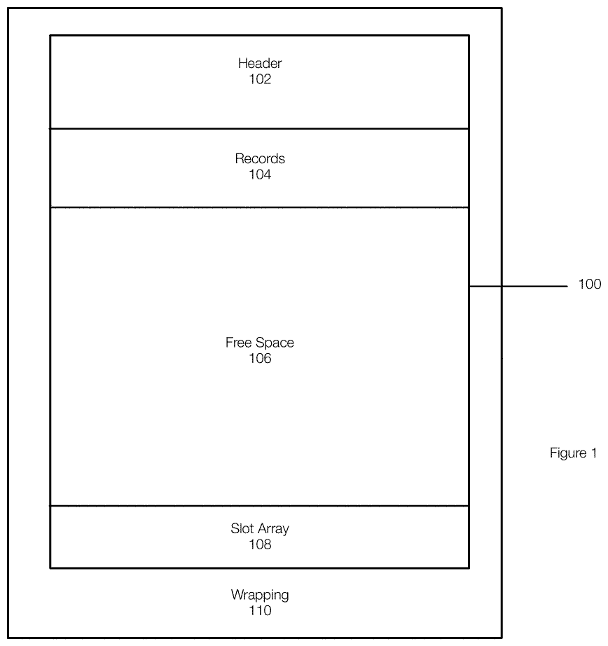

In one example, a database server may represent all of its structures in pages of a particular size. For example, a SQL server represents its structures in 8 KB pages. FIG. 1 illustrates and example of a page of a database. FIG. 1 illustrates a page 100 whose size is 8K. The 8K of the page 100 includes a header 102 (e.g., 96 bytes), records 104 (data stored in the page), free space 106 (space not currently used in the page) and a slot array 108 (indicating the order of rows in the data region or in the records 104).

When the page 100 is encrypted and/or compressed, the encryption and/or compression is typically applied only to the records 104. The headers 102 are not encrypted or compressed. Thus, from the perspective of a data protection system, only the records 104 of the page 100 are encrypted and/or compressed. Also, when the page 100 is backed up, the page 100 may be wrapped in extra content such as the wrapping 110 created by the backup application or software. However, the page 100 remains intact within the wrapping. The wrapping 110 may encompass a plurality of pages 100. Further, page boundaries are respected during different types of backup operations, such as when performing a striped backup.

In order to efficiently backup a database or the pages of a database or to de-duplicate the backups, it is necessary to identify or find the pages such that duplicate pages (or duplicate blocks) can be identified and handled. Finding the pages in the backups may be referred to as segmentation. Thus, pages are located when a backup or backup stream is segmented. When a backup is properly segmented, the data can be more efficiently de-duplicated at least because the records 104 can be identified and effectively compared, even in their encrypted and/or compressed state, with records of other pages in the present backup or in other backups. Further, the embodiments of the invention including segmentation and/or de-duplication may be performed on a backup stream.

Because the structure of all pages is the same, embodiments of the invention segment or locate pages by finding or identifying the header 102 or header region of the page 100. The header 100 typically includes multiple fields and these fields are defined by the database application. The page 100 can be identified or located by understanding the field values and/or the relationships between field values in the header 102.

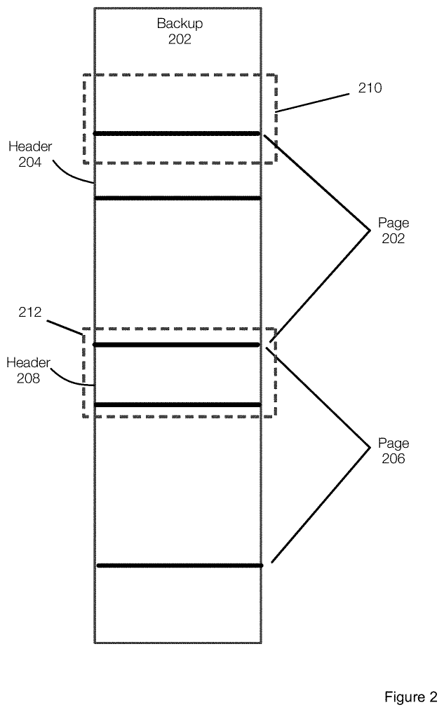

Embodiments of the invention can be implemented as the backup operation is being performed and/or after the backup has been stored. FIG. 2 illustrates an example of a backup or a backup stream. FIG. 2 also illustrates an example of locating or identifying a header or a header region of a page in the backup or in the backup stream. When the header is located, the page is located at least because the page size is known. When the pages are stored sequentially, the locations of subsequent pages are also known by simply adding 8K to the start of the located page. These pages can be confirmed with a check that is usually less complex than the checks used to identify the initial page.

More specifically, FIG. 2 illustrates a backup 202 that includes multiple pages, which are illustrated as pages 202 and 206. These pages may be wrapped as previously stated. For discussion purposes, two pages are illustrated. The page 202 has a header 204 and the page 206 has a header 208. However, the pages 202 and 206 have the structure discussed with reference to FIG. 1.

Embodiments of the invention may segment the backup 202 by identifying or finding a header in the backup 202. Once a header is found, additional pages in the backup 202 can be located by simply adding the page size (e.g., 8 KB) to the starting location of the found header. Because all pages have this size, the pages are found at addresses or locations of 8KB increments.

In one example, the backup 202 is evaluated using a window 210. The window 210 is used to locate a header in the backup 202. In this example, the window 210 is the same size as the header of the pages in the backup 202. By way of example only, the window 210 has a size of 96 bytes in this example. Thus, the window 210 allows 96 bytes of the backup 202 to be evaluated at a time.

FIG. 2 further illustrates a window at two different locations, which may correspond to different points in time or to two different evaluations of the backup 202. The bytes inside the window 210 are evaluated to determine whether a header of a page has been found. In this example, the header 204 is only partially within the window 210. As a result, a header is not found. Embodiments of the invention find the first header in the backup 202. For illustration purposes and clarity in the Figure, the located header is illustrated as header 208.

When the result of the evaluated bytes inside the window 210 is negative or false, the window is advanced. In one example, the window may be advanced by 4 bytes or by another number. The bytes inside the window 210 after moving the window 210 are then evaluated to determine if a header is found.

Eventually, the window is advanced to the position shown by the window 212. FIG. 2 illustrates that the window 212 is evaluating data in the backup 202 that corresponds to the header 208. Because the 96 bytes in the window 212 correspond to a valid header 208, the page 206 has been found. Subsequent pages can be found by adding 8 KB to the starting location or address of the page 206 as previously stated.

Identifying or locating a header involves an analysis or evaluation of the data stored in the 96 bytes. With regard to the page 100 in FIG. 1, the header 102 includes a plurality of defined fields. Each field may occupy one or more bytes. This allows the bytes in the window 212 to be associated with the defined fields of the header 208. As a result, specific bytes in the window 212 can be compared to expected values of corresponding fields.

The header 102 may include the following fields. The length of the various fields can be determined from the following table.

| Bytes | Content |
|---|---|
| 00 | HeaderVersion |
| 01 | Type |
| 02 | TypeFlagBits |
| 03 | Level |
| 04-05 | FlagBits |
| 06-07 | IndexID |
| 08-11 | PreviousPageID |
| 12-13 | PreviousFileID |
| 14-15 | Pminlen |
| 16-19 | NextPageID |
| 20-21 | NextPageFileID |
| 22-23 | SlotCnt |
| 24-27 | ObjectID |
| 28-29 | FreeCnt |
| 30-31 | FreeData |
| 32-35 | PagelD |
| 36-37 | FileID |
| 38-39 | ReservedCnt\| |
| 40-43 | Lsn1 |
| 44-47 | Lsn2 |
| 48-49 | Lsn3 |
| 50-51 | XactReserved |
| 52-55 | XdesIDPart2 |
| 56-57 | XdesIDPart1 |
| 58-59 | GhostRecCnt |
| 60-63 | Checksum/Tombits |
| 64-95 | Content |

These header fields are defined and may include certain values or ranges of values. The bytes covered by the window can be evaluated to determine whether the values of the data in the backup 202 selected by the window 212 correspond to expected values for the corresponding header fields or are within expected ranges. Further, embodiments of the invention may only evaluate a subset of the headers.

During evaluation, the data at the appropriate location in the window is compared to the expected value or to a range of expected values. If all of the evaluations are true, then embodiments of the invention determine that a page has been located.

The following identifies certain field header and their expected values.
Header version: Only version 1 is currently in use and the expected value is 1.
Type: Values from 1-23 are expected to be present in these bytes and these values and correspond to types such as a data page, an index page, etc.
Type flag bits: 0, 1, 4, 128 are seen in practice. 0, 1, and 4 are the most common values. Thus, the expected values are 0, 1, 4 and 128.
Level: This is typically a small value. Embodiments of the invention may set a threshold level. For example, the value in this field is expected to be less than 6. Another threshold value could be selected.
Slot count: This field identifies the number of records in a page. Records have a minimum size, so this value has a cap. In other words, the value must be lower than the cap due to the minimum size of each record and the limited space in the page. The cap is typically the space in the page divided by the minimum size. The slot count field is related to the following fields.
   Free count: This is the number of free bytes in a page. The free bytes are not necessarily consecutive. This value is less than or equal to the amount available in the page for data.
   Free Data: This field is an offset from the start of a page to the first byte after the last record and may indicate the starting location of free data. This value is expected to be greater than the header (96 bytes) and less than the position of the slot array.
   Checksum: This field is an XOR of 128 byte sub-pages with a circular shift between sub-pages, skipping the checksum field itself. The value can be checked to confirm a header is correctly identified.

In one example, the data contained in the bytes of the window corresponding to the location of these fields are compared to the expected values. For example, byte 00 in the window is compared to an expected value of 1. If the comparisons are all true or positive, then a header is likely found. Thus, a page can be potentially identified using less than all of the fields in the header.

Embodiments of the invention may further consider relationships when identifying a page. For example, the Free count field must be less than or equal to the space available for records. The slot count field is the number of records, and each record requires at least 8 bytes. The free data field must have a value after the header (96 bytes) and less than the position of the slot array.

While the checksum field could have a value of 0, there may be, for example, a 1 in 4 billion chance of that occurring. Thus, the expected value is not 0. This may cause, in rare cause, a page to be missed. Plus, rejecting potential page headers with a Checksum value of 0 is useful because zeroed fields are common for uninitialized regions of a backup.

When a header is found that matches these requirements, the header may be determined to be the beginning of an 8KB page. The segmentation process may then skip to the end of the page (advance 8 KB) and begin evaluating the backup for another page header. Even if page header identification process has the occasional false-positive, once the process has locked onto or located a true or valid page, the process will continue to match on the following pages in the backup and skip regions within pages that could be false positives.

Embodiments of the invention can enforce a maximum and minimum segment size in regions when a page header is not found. Such regions likely contain structures added by the backup software. However, these records tend to be a small fraction of the data being backed up from the SQL Server database. This small fraction of the data is still backed up, but may not necessarily be de-duplicated.

Embodiments of the invention can operate in multiple configurations. Data configuration (the manner in which the pages are configured) may include encryption, row compression, page compression, multiple backup streams, or the like or combination thereof.

In one example, the segmentation process may initially search over a certain or predetermined byte range of the backup. In a system where the pages are 8KB, the initial search using a window that advanced through the data a certain number of bytes at a time (e.g., 4 bytes). This initial search may search the first 4KB to 12 KB of the backup for a valid header. Even if the search for the first header is computationally expensive, subsequent pages are found in a manner that is much less expensive computationally. As previously stated, once a header is found based on the criteria discussed herein, the window can be advanced 8KB and then check whether a header is found. If a header is found, a segment is formed or located and the window is advanced 8KB.

Various optimizations can be added to this approach. For example, more than one check may be performed when identifying a header. These checks may include strong and weak checks. Weak checks are usually less expensive computationally than strong checks. A weak check of whether certain fields in a header are correct can be performed for example. A strong check may include performing a checksum over the full 8KB page to determine if the checksum matches the checksum in the header.

Once a header is identified using one or more weak checks and/or one or more strong checks, a weak check could be applied to the data at the next page position, which is 8KB away in one example. For example, a page header includes a page ID. The next page header likely has the consecutive page ID, which can be checked quickly. This is an example of a weak check. Thus, the segmentation of the backup 202 can be performed using strong and weak checks. Further, even if locating the initial page is computationally expensive and may include strong and weak checks, the identification of subsequent pages can be performed more quickly.

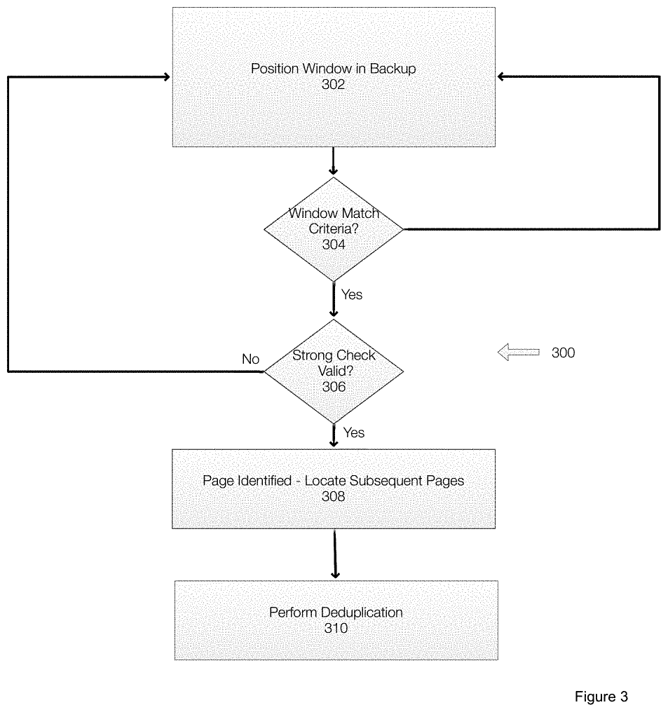

FIG. 3 illustrates an example of a method for segmenting a backup. The segmentation method 300 typically begins by positioning 302 a window in a backup. Stated differently, a particular set of data is selected for evaluation and analysis. In one example, the number of bytes corresponding to a header portion of a page is selected. Thus, the window is positioned in the backup to identify a set of data for evaluation.

The selected data may be evaluated using weak and/or strong checks. For example, some of the bytes in the window may be compared to header criteria 304. The header criteria may include expected values for the header fields. This may include a plurality of comparisons and may include comparing certain header fields (the data in the window at the locations of those header fields) with expected values or ranges of values for those header fields. If this comparison fails (NO) (e.g., one or more of the comparisons is false), then the window is positioned by advancing the window by a certain amount. Advancing the window in this manner may be repeated until the window matches the header criteria (YES at 304).

When the header criteria is satisfied, a strong check may be performed. The strong check may include determining a checksum of the page and comparing the checksum with the data in the window corresponding to the checksum header field. If the strong check fails (NO at 306), the window is advanced. If the strong check is positive (YES at 308), then a page is identified or located in the backup and subsequent pages are located 308.

In one example, the identification of subsequent pages may include simply advancing the window by 4 bytes and performing at least a weak check. Alternatively, subsequent pages may be located by advancing the window an amount equal to the page size and then evaluating the data in the repositioned window. Once an initial page has been found, the location of subsequent pages may only require a weak check, such as evaluating the data in the window with the expected header field values or evaluating the page ID.

When segmentation is part of a backup operation, the method may deduplicate 310 the data. In one example, a hash of the records 104 or of the data portion (or other identifier) of the page may be compared with hashes of already backed up data. A match allows the data to be de-duplicated. Alternatively, a hash of the entire page may be compared with hashes of already backed up data.

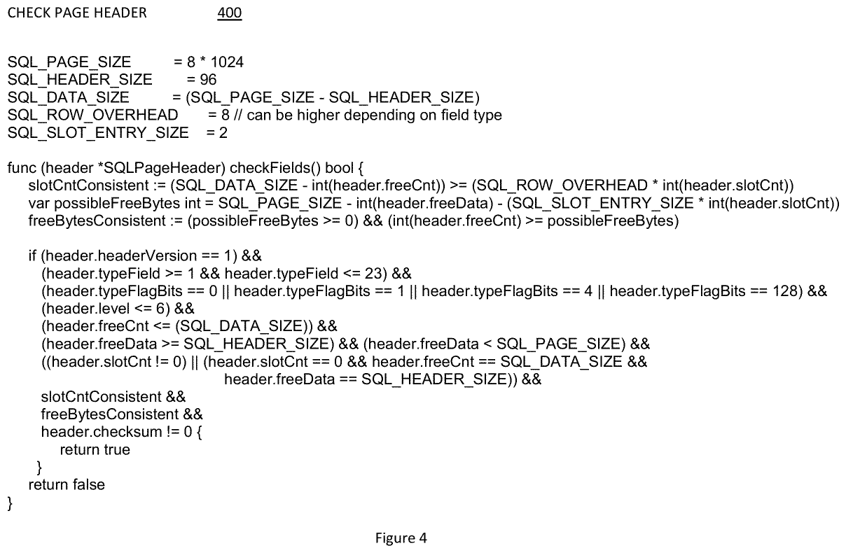

FIG. 4 illustrates an example of pseudocode for segmenting a backup or a backup stream (or other data).

The pseudocode 400 illustrates, by way of example and not limitation, that a page size is 8KB, a header size is 96 bytes, a data size is 8 KB-96 bytes, row overhead=8, but can be higher, and slot entry size=2.

The pseudocode 400 is an example of a first check and involves comparing data in the window with expected values and comparing relationships between the data in the window. For example, the slot count is consistent when the difference between the data size and the free count (data size—the free count) is greater than or equal to the product of the row overhead and the slot count (row overhead *slot count).

In this example, the possible free bytes equals the page size minus the free data—the product of the slot entry size times the slot count. The free bytes is consistent when the possible free bytes is greater than or equal to 0 and the free count is greater than or equal to the possible free bytes.

These values (slot consistent and free bytes consistent) check relationships between some of the values in the window whose positions in the window correspond to header fields of a page.

The next portion of the pseudocode compares specific data to expected values as previously described. When all of these comparisons are true, a header is presumed to be located.

The segmentation discussed herein can be performed by the backup application or at a deduplication server after the backup operation is completed.

In one embodiment, once a page is identified, weak checks can be performed on following pages or to identify following pages. More specifically, identifying the initial page in the backup may consume weak and strong checks to ensure that a page has been identified. Subsequent pages can be identified using weak and/or strong checks. Further, embodiments of the invention may involve machine learning or be updated based on the accuracy with which pages are segmented.

For example, multiple header field values may be evaluated to determine whether the data corresponds or identifies a page header. The checksum may also be evaluated. If there are mismatches (e.g., the header check fails while the checksum matches or the checksum fails while the header check succeeds), then these mismatches are evaluated in order to update the manner in which pages are identified or located. This may include changing the expected values or ranges, using a different combination of header fields, or the like.

Embodiments of the invention thus determine the presence of a header by evaluating the data in the window to determine if the data conforms to expected values or to determine whether certain portions of the data in the window have certain relationships with other portions of the data. Embodiments of the invention are not limited to any particular header fields or combinations of header fields. Embodiments of the invention are not limited to specific relationships. One of skill in the art, with the benefit of the present disclosure, can appreciate that the relationships and expected values can be determined from the structure of the header region.

It should be appreciated that the present invention can be implemented in numerous ways, including as a process, an apparatus, a system, a device, a method, or a computer readable medium such as a computer readable storage medium or a computer network wherein computer program instructions are sent over optical or electronic communication links. Applications may take the form of software executing on a general purpose computer or be hardwired or hard coded in hardware. In this specification, these implementations, or any other form that the invention may take, may be referred to as techniques. In general, the order of the steps of disclosed processes may be altered within the scope of the invention.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein.

As indicated above, embodiments within the scope of the present invention also include computer storage media, which are physical media for carrying or having computer-executable instructions or data structures stored thereon. Such computer storage media can be any available physical media that can be accessed by a general purpose or special purpose computer.

By way of example, and not limitation, such computer storage media can comprise hardware such as solid state disk (SSD), RAM, ROM, EEPROM, CD-ROM, flash memory, phase-change memory (“PCM”), or other optical disk storage, magnetic disk storage or other magnetic storage devices, or any other hardware storage devices which can be used to store program code in the form of computer-executable instructions or data structures, which can be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ can refer to software objects or routines that execute on the computing system. The different components, modules, engines, and services described herein may be implemented as objects or processes that execute on the computing system, for example, as separate threads. While the system and methods described herein can be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention can be performed in client-server environments, whether network or local environments, or in any other suitable environment. Suitable operating environments for at least some embodiments of the invention include cloud computing environments where one or more of a client, server, or target virtual machine may reside and operate in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for segmenting a backup, the method comprising:
positioning a window over a portion of the backup, wherein the window identifies data of the backup;
performing a first check between portions of the identified data in the window and expected values for the portions of the identified data;
determining that the window corresponds to a header of a page when the first check is positive; and
determining a location of the page in the backup.

2. The method of claim 1, further comprising determining locations of subsequent pages in the backup based on the location of the page.

3. The method of claim 1, further comprising a second check of the page based on the identified data.

4. The method according to claim 3, wherein the second check includes comparing a checksum of the page with data in the window corresponding to the checksum.

5. The method according to claim 1, wherein the identified data has a size corresponding to a size of a header of the page.

6. The method according to claim 1, wherein the first check includes comparing specific portions of the identified data with expected values for the specific portions of the data.

7. The method according to claim 6, wherein the expected values include a particular value, a range of values, or a set of values.

8. The method according to claim 1, wherein the first check includes a plurality of comparisons, wherein the window corresponds to the header of the page when all of the plurality of comparisons are true.

9. The method according to claim 1, further comprising moving the window when the first check fails such that the window identifies new data and performing the first check on the new data.

10. The method according to claim 8, further comprising comparing data in the window corresponding to a header field, a flag field, a level field, a free count field, a free data field, and a slot count field with expected values, respectively, of the header field, the flag field, the level field, the free count field, the free data field, and the slot count field.

11. The method according to claim 4, further comprising adjusting at least the first check when the first check fails and the second check succeeds or the first check succeeds and the second check fails, wherein adjusting at least the first check includes at least one of changing expected values for header fields involved in the first check and/or selecting a different combination or header fields used in the first check.

12. A method for segmenting a backup, the method comprising:
positioning a window over a portion of the backup, wherein the window identifies data of the backup;
performing a first check between portions of the identified data in the window and expected values for the portions of the identified data;
performing a second check on a page that begins with the identified data; and
determining a location of a valid page in the backup when both the first check and the second check are positive.

13. The method of claim 12, further comprising determining locations of subsequent pages in the backup based on the location of the page.

14. The method of claim 13, wherein only a third check is used to determine the locations of subsequent pages.

15. The method of claim 14, wherein the third check is the same as or different from the first check.

16. The method of claim 15, wherein the third check includes evaluating a page identifier or performing a plurality of comparisons between data in the window with expected values of the data.

17. The method according to claim 12, wherein the second check includes comparing a checksum of the page with data in the window corresponding to the checksum.

18. The method according to claim 12, further comprising advancing the window by a set amount when one of the first check and the second check fails and performing the first check and the second check with respect to new data in the repositioned window.

19. The method according to claim 12, wherein the first check includes evaluating expected values of data in the window and evaluating relationships between data in the window.

20. The method according to claim 12, wherein the expected values include a particular value, a range of values, or a set of values.

21. The method according to claim 12, wherein the window is advanced by a page size when a valid header is located.
